(19) United States
(12) Patent Application Publication
(10) Pub. No.: US 2020/0207301 A1
(43) Pub. Date: Jul. 2, 2020

(54) ENERGY ABSORBING NETS

(71) Applicant: Waymo LLC, Mountain View, CA (US)

(72) Inventors: Peter Craig Lombrozo, Santa Cruz, CA (US); Daniel Lynn Larner, San Jose, CA (US); Atul Gupta, San Jose, CA (US)

(21) Appl. No.: 15/698,150

(22) Filed: Sep. 7, 2017

(51) Int. Cl. B60R 21/34; B60R 21/08

(52) U.S. Cl. CPC B60R 21/34; B60R 2021/0004; B60R 21/08

(57) ABSTRACT

Aspects of the disclosure relate to net systems. The net system reduces the risk of injury caused by impact with a vehicle to an object or a pedestrian. The net system may include a net configured to deploy in a vehicle's environment in order to reduce the likelihood of an object colliding directly with the vehicle. The one or more energy reduction structures may be arranged on the net, and the one or more energy reduction structures may be configured to reduce injury caused by impact of the object by absorbing impact energy.

### BACKGROUND

Autonomous vehicles, such as vehicles that do not require a human driver, can be used to aid in the transport of passengers or items from one location to another. Such vehicles may operate in a fully autonomous mode where passengers may provide some initial input, such as a pick up or destination location, and the vehicle maneuvers itself to that location.

A component of an autonomous vehicle is the perception system, which allows the vehicle to perceive and interpret its surroundings using cameras, radar, sensors, and other similar devices. Data from the perception system is then used by the autonomous vehicle's computer to make numerous decisions while the autonomous vehicle is in motion, such as deciding when to speed up, slow down, stop, turn, etc. These decisions are used to maneuver between locations, but also to interact with and avoid collisions with other objects along the way.

In advance of, or upon a collision non-autonomous and autonomous vehicles alike may deploy various safety mechanisms to reduce injury to passengers and pedestrians. Typically, the safety mechanisms may include airbag systems employed to protect passengers from impacts with the interior of a vehicle after an object external to a vehicle has impacted a bumper of the vehicle.

### BRIEF SUMMARY

Embodiments within the disclosure relate generally to net systems to reduce the risk of injury caused by impact with a vehicle to an object or a pedestrian. The system may comprise a net configured to deploy in a vehicle's environment in order to reduce the likelihood of an object colliding directly with a vehicle and one or more energy reduction structures arranged on the net, wherein the one or more energy reduction structures are configured to reduce injury caused by impact of the object by absorbing impact energy.

In some embodiments the one or more energy reduction structures may include at least one link breaking device. The at least one link breaking device may be configured to tear apart at a predetermined tension threshold.

In some embodiments the one or more energy reduction structures include at least one hobbling string. The one hobbling string may be configured to tear apart at a predetermined tension threshold.

In some embodiments the net may be configured to deploy within the vehicle's interior environment.

In some embodiments the one or more energy reduction structures may include one or more slip knots. The one or more slip knots may include at least one net anchor slip knot, the at least one net anchor slip knot securing the net to one or more supports. The one or more energy reduction structures may further include at least one other energy reduction structure. The one or more slip knots may include basic slip knots, pop-stop slip knots. The one or more slip knots may be positioned throughout the net.

In some embodiments the net is positioned on the vehicle.

In some embodiments the net is stored in a compartment attached to the vehicle.

Another aspect may include a method for deploying a net in a vehicle's vicinity in order to reduce the likelihood of an object colliding directly with the vehicle. The method may include determining, by one or more processors, a collision with the object is imminent. The one or more processors may predict a location on the vehicle where the collision with the object is expected to occur and determine a first net at the location on the vehicle where the collision is expected to occur. The one or more processors may send a triggering signal to deploy the first net and in response to receiving the triggering signal, deploying by one or more processors, the first net, wherein the first net includes at least one energy reduction structure arranged on the first net, wherein the at least one energy reduction structure is configured to reduce injury caused by impact of the object by absorbing impact energy.

### BRIEF DESCRIPTION OF THE DRAWINGS

FIG. 1 is a diagram of components within a vehicle in accordance with aspects of the disclosure.

FIGS. 2A-2F are example external views of a vehicle including a net system in accordance with aspects of the disclosure.

FIGS. 3A and 3B are example views of a net attached to supports in accordance with aspects of the disclosure.

FIG. 4A is an illustration of a net attached to a support using net anchor slip knots in accordance with aspects of the disclosure.

FIG. 4B is an illustration of a net anchor slip knots pulled taut against a support in accordance with aspects of the disclosure.

FIGS. 5A-5D are illustrations of slip knots in accordance with aspects of the disclosure.

FIGS. 6A and 6B are illustrations of slip knots positioned within strands of a net next to a support in accordance with aspects of the disclosure.

FIGS. 7A and 7B are illustrations of slip knots positioned within strands of a net in accordance with aspects of the disclosure.

FIGS. 8A and 8B are illustrations of slip knots formed by adjacent strands of a net in accordance with aspects of the disclosure.

FIGS. 9A and 9B are illustrations of hobbling strings attached to a net in accordance with aspects of the disclosure.

FIGS. 10A-10D are illustrations of link breaking devices attached to a net in accordance with aspects of the disclosure.

FIG. 11 is an illustration of a net attached to a net attached to a support via a cable in accordance with aspects of the disclosure.

FIGS. 12A and 12B are illustrations of telescoping tubes in accordance with aspects of the disclosure.

FIGS. 12C and 12D are illustrations of pivoting supports in accordance with aspects of the disclosure.

FIGS. 13A and 13B are illustrations of supports attached to springs in accordance with aspects of the disclosure.

FIG. 14 is an illustration of an external net system that covers a lower portion of a vehicle in accordance with aspects of the disclosure.

FIG. 15 is an illustration of an external net system that covers an upper portion of a vehicle in accordance with aspects of the disclosure.

FIGS. 16A-16H are illustrations of triangular support structures in accordance with aspects of the disclosure.

FIGS. 17A and 17B are illustrations of supports made of airbags in accordance with aspects of the disclosure.

FIGS. 18A and 18B are illustrations of a net attached to a vehicle panel in accordance with aspects of the disclosure.

FIG. 19 is an example situational diagram in accordance with aspects of the disclosure.

FIG. 20 is an example flow diagram in accordance with aspects of the disclosure.

### DETAILED DESCRIPTION

### Overview

This technology relates to an external net system which reduces the potential of impact injuries to pedestrians or other objects impacted by a vehicle. For example, in the event of a vehicle impact with a pedestrian, considerable injury may result to the pedestrian. Computing devices within a vehicle may determine that an impact with an object, such as a pedestrian, cannot be avoided by way of decelerating, steering, and/or accelerating the vehicle. When this is the case, the computing devices may deploy an external net across the vehicle to absorb the impact of the pedestrian and stop the pedestrian from making direct contact with the vehicle. This in turn may help reduce impact injuries to the pedestrian and in some cases, save lives.

Prior to deployment, an external net system may be mounted in a compartment arranged at various locations on a vehicle. The external net system may be comprised of multiple components including at least one net. The net may be attached to one or more supports also arranged within the compartment. The supports may be configured to hold the net in a deployed position such that the net blocks the pedestrian from making contact with the vehicle. The external net system may further include a deployment tool to accomplish deployment of the supports and/or the net from a compartment.

The net may made from cordage or webbing. The net may also be comprised of a strong fabric, nylon, polyester, or other similar material. The net may be of various shapes, such as, for example, square, rectangular, trapezoidal, triangular, oval, etc.

The net may be situated between the supports of the external net system. For example one side of the net may be attached across a portion of a first support extending between a base of the first support to a top portion of the first support. An opposite side of the net may be attached across a portion of a second support extending from around a base of the second support to a top portion of the second support.

The net may be attached to the supports using various attachment tools, such as cable ties, adhesives, clips, clamps, anchors, hooks, snaps, hook and loop straps, cords looped into holes in the supports, sleeves on each side of the net, etc. In an example, the net may be attached to the supports using net anchor slip knots. In this regard, the strands of the net may be terminated with slip knots and attached to the supports.

Upon impact with a pedestrian, the tension in the strands of the net may increase, thereby causing the strands to slip through the knots. The strands may slip through the knots until the knots are taut against the support.

The energy absorption of the slip knots may be adjusted based on the length of the loop of the slip knot. In this regard, the string, or other material, which comprises the knot will untie and lengthen upon a force being applied. As the slip knot unties, energy is absorbed by the net.

Slip knots may be included throughout the body of the net. For example, slip knots may be spaced evenly throughout the net, although the spacing of the slip knots may be uneven. The number and placement of slip knots throughout the net may be dependent upon the amount of energy absorption needed. In this regard, the more slip knots within the net, the more energy the net will absorb as the slip knots unwind.

Hobbling strings may be included throughout the body of the net to absorb impact energy. Hobbling strings may be designed to break at a predetermined tension. For example, hobbling strings may be attached to nodes of the net to bring the nodes of the net closer together. Upon impact with a pedestrian, a predetermined impact threshold may be reached, causing the hobbling strings to break and allowing the net to absorb energy in this breaking. A net may include hobbling strings designed to break at different tensions, to allow for controlled energy absorption.

The net may include link breaking devices to absorb impact energy. In this regard, section of the net may be overlapped and stitched together. For example, sections of the net may be overlapped and stitched together to form a link breaking device. Upon the link breaking device experiencing a predetermined level of tension, the stitches may break resulting in the lengthening of the net. Dependent upon the strength of the stitching material, the level of tension required to break the link breaking device may be adjusted, thereby allowing for controlled release of the link breaking device.

The features described herein may allow for improved safety in and around a vehicle. In this regard, the vehicle may offer safety measures to individuals and objects outside of the vehicle such that the vehicle can operate in environments close to pedestrians and other external objects with a reduced chance of causing injury or damage to the pedestrians or objects in the case of an inadvertent collision. Additionally, the features described herein may allow for improved safety of passengers inside of the vehicle. In this regard, the safety measures may be positioned within the interior of the vehicle to reduce the chance of injury or damage to the passengers in the case of an inadvertent collision.

In addition, as discussed in detail below, the features described herein allow for various alternatives.

### EXAMPLE SYSTEMS

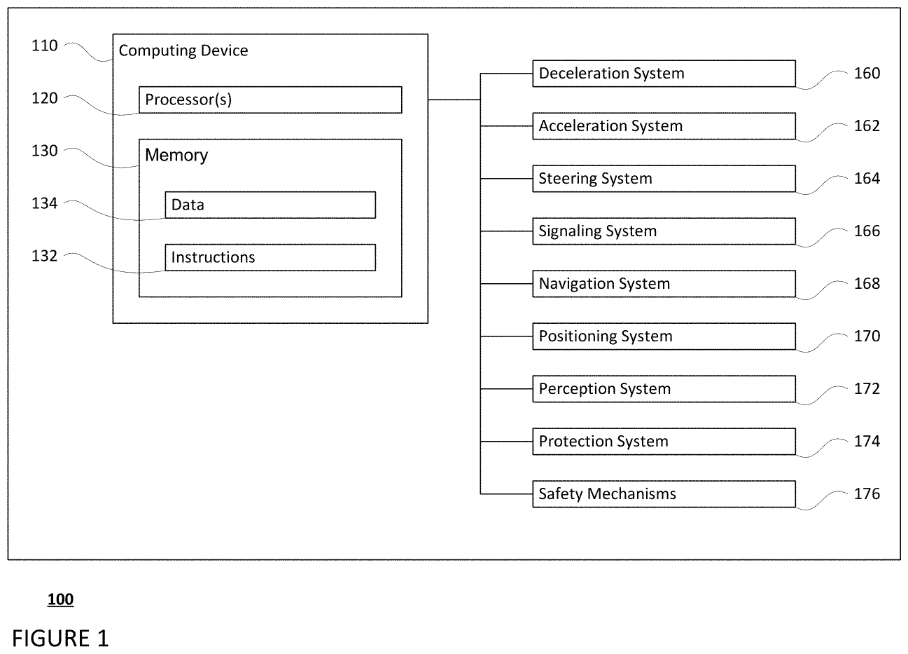

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio visual experiences. In this regard, internal electronic display 152 may be located within a cabin of vehicle 100 and may be used by computing device 110 to provide information to passengers within the vehicle 100.

Computing device 110 may also include one or more wireless network connections 154 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

In one example, computing device 110 may be an autonomous driving computing system incorporated into vehicle 100. The autonomous driving computing system may capable of communicating with various components of the vehicle. For example, returning to FIG. 1, computing device 110 may be in communication with various systems of vehicle 100, such as deceleration system 160, acceleration system 162, steering system 164, signaling system 166, navigation system 168, positioning system 170, and perception system 172, and protection system 174 in order to control the movement, speed, etc. of vehicle 100 in accordance with the instructions 134 of memory 130. Again, although these systems are shown as external to computing device 110, in actuality, these systems may also be incorporated into computing device 110, again as an autonomous driving computing system for controlling vehicle 100. As with the computing device 110, each of these systems may also include one or more processors as well as memory storing data and instructions as with processors 120, memory 130, data 132 and instructions 134.

As an example, computing device 110 may interact with deceleration system 160 and acceleration system 162 in order to control the speed of the vehicle. Similarly, steering system 164 may be used by computer 110 in order to control the direction of vehicle 100. For example, if vehicle 100 is configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 134 may store detailed map information, e.g., highly detailed maps identifying the shape and elevation of roadways, lane lines, intersections, crosswalks, speed limits, traffic signals, buildings, signs, real time traffic information, vegetation, or other such objects and information.

Positioning system 170 may be used by computing device 110 in order to determine the vehicle's relative or absolute position on a map or on the earth. For example, the position system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with computing device 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

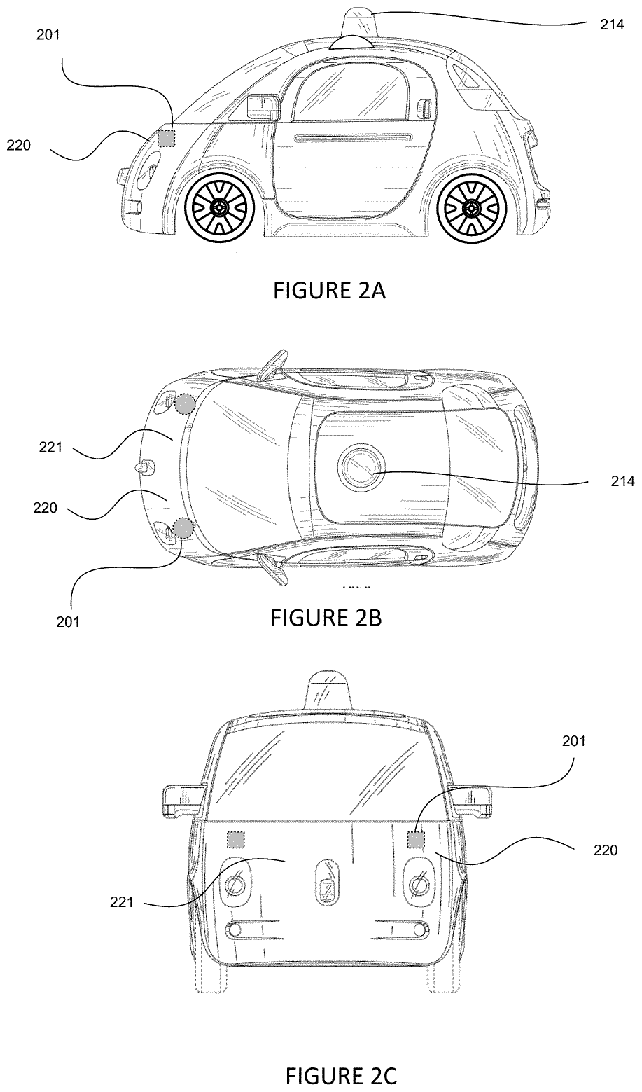

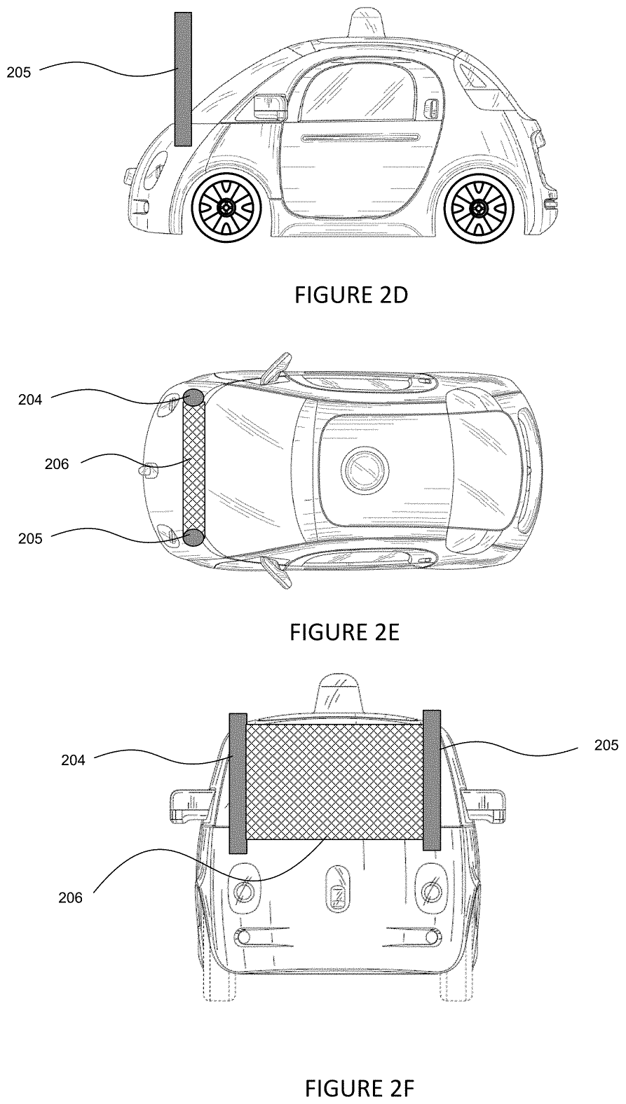

The perception system 172 also includes one or more components for detecting objects external to the vehicle such as other vehicles, obstacles in the roadway, traffic signals, signs, trees, etc. For example, the perception system 170 may include lasers, sonar, radar, cameras and/or any other detection devices that record data which may be processed by computing device 110. In the case where the vehicle is a small passenger vehicle such as a car, the car may include a laser sensor 214 (shown in FIGS. 2A and 2B) or other sensors mounted on the roof or other convenient location.

The computing device 110 may control the direction and speed of the vehicle by controlling various components. By way of example, computing device 110 may navigate the vehicle to a destination location completely autonomously using data from the detailed map information and navigation system 168. Computing device 110 may use the positioning system 170 to determine the vehicle's location and perception system 172 to detect and respond to objects when needed to reach the location safely. In order to do so, computing device 110 may cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the acceleration system 162 and deceleration system 162 may be a part of a drivetrain that includes various components between an engine of the vehicle and the wheels of the vehicle. Again, by controlling these systems, computing device 110 may also control the drivetrain of the vehicle in order to maneuver the vehicle autonomously.

The sensors of perception system 172 may detect objects in the vehicle's environment as well as characteristics of those objects such as their location, heading, size (length height and width), type, and approximate center of gravity. For example, the perception system may use the height of an object identified as a pedestrian (or human) to estimate the approximate center of gravity of the object. In this regard, the perception system may compare the characteristics of the object to known anthropomorphic data to determine an approximate center of gravity. For other object types, the approximate center of gravity may be determined from the characteristics of the object using various known statistical analyses. Data and information required for these determinations may be stored, for example, in memory 130 or a different memory of the perception system.

As discussed in more detail below, information from the perception system may be sent to various other systems in order to make decisions about when and how to deploy various safety mechanisms. In this regard, the perception system may send the information to the vehicle's computing devices which make such decisions and forward activation instructions to protection system 174 which deploys one or more safety mechanisms 176 in accordance with the activation instructions. In another example, the perception system 172 may forward the information directly to the protection system 174 which makes then determines whether and how to deploy one or more safety mechanisms 176.

Thus, the vehicle may also include a plurality of safety mechanisms 176. These safety mechanisms may be configured to reduce the likelihood of damage to objects outside of the vehicle as opposed to those meant to specifically protect passengers inside the vehicle. At least some of these safety mechanisms may be active, in that the device must be activated or deployed by a signal generated by one or more computing devices when an impact is imminent.

The one or more safety mechanisms 176 may include one or more external net systems. An external net system may be mounted in a compartment arranged at various locations on a vehicle. For example, an external net system 201 may be mounted in the interior of a front portion 220 of the vehicle 100, as shown in FIGS. 2A, 2B, and 2C. In this example, front portion 220 corresponds to a hood panel 221 for an engine compartment.

The external net system may be comprised of multiple components. For instance, the external net system may include at least one net. The net may be attached to one or more supports also arranged within the compartment. For example, as shown in FIGS. 2D, 2E, and 2F, supports 204 and 205 may be configured to hold the net 206 in a particular deployed position. In this regard, the net is situated between the supports of the external net system when in a deployed position, such that the net blocks the pedestrian from making contact with the vehicle. The external net system may further include a deployment tool to accomplish deployment of the supports and/or the net from a compartment.

The net may be a traditional net, such as a net made from strands of cordage or webbing. In this regard, the strands may be woven or combined together to form webbing of the net. The net may also be a sheet of a strong fabric, nylon, polyester, or other similar material. The net may be of various shapes. For example, the net 206 may be square, rectangular, trapezoidal, triangular, oval, etc. The net may also contain energy reduction structures, which may assist in dissipating impact energy.

The net may be backed by a thin fabric to prevent entanglement during deployment. In this regard, the thin fabric may prevent the cordage or webbing from becoming tangled when in a stored position. The thin fabric may also include energy reduction structures, such as knots and link breaking devices, to further increase the energy absorption during impact with an object.

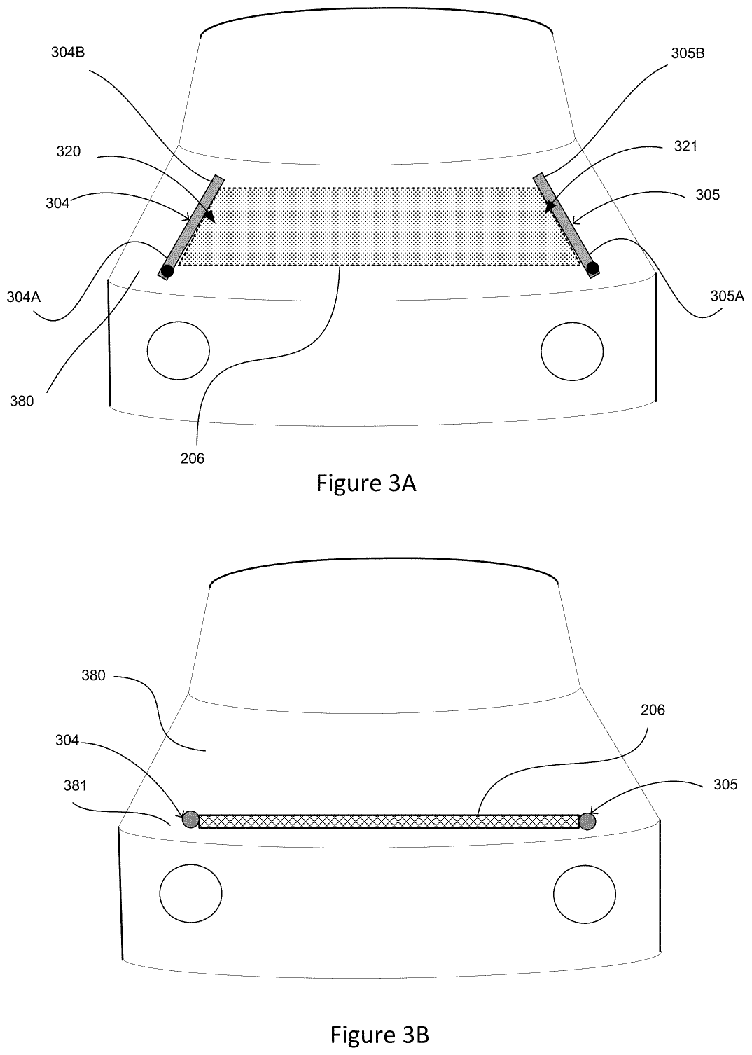

Portions of the net may be attached to the supports. For example, as shown in FIG. 3A, prior to deployment, the net 206 is spread across a hood panel 380, while being attached to supports 304 and 305, which may be compared to supports 204 and 205. The supports 304 and 305 are arranged to lie on the hood panel 380. In this regard, a first side 320 of the net 206 may be attached across a portion of a first support 304, the portion extending between the base 304A of the first support 304 to the top portion 340B of the first support 304. A second side 321 of the net 206, opposite of the first side 320, may be attached across a portion of a second support 305, the portion extending between the base 305A of the second support 305 to the top portion 305B of the second support 305. In some instances, prior to deployment, net 206 may be compactly arranged near the leading edge 381 of hood panel 380, while being attached to supports 304 and 305 that are incorporated within the hood panel 380, as shown in FIG. 3B. Although the figures show the net being deployed outside of the vehicle, the net may be suspended within the vehicle, such as between the front and rear seats of the vehicle to protect the vehicle's passenger(s).

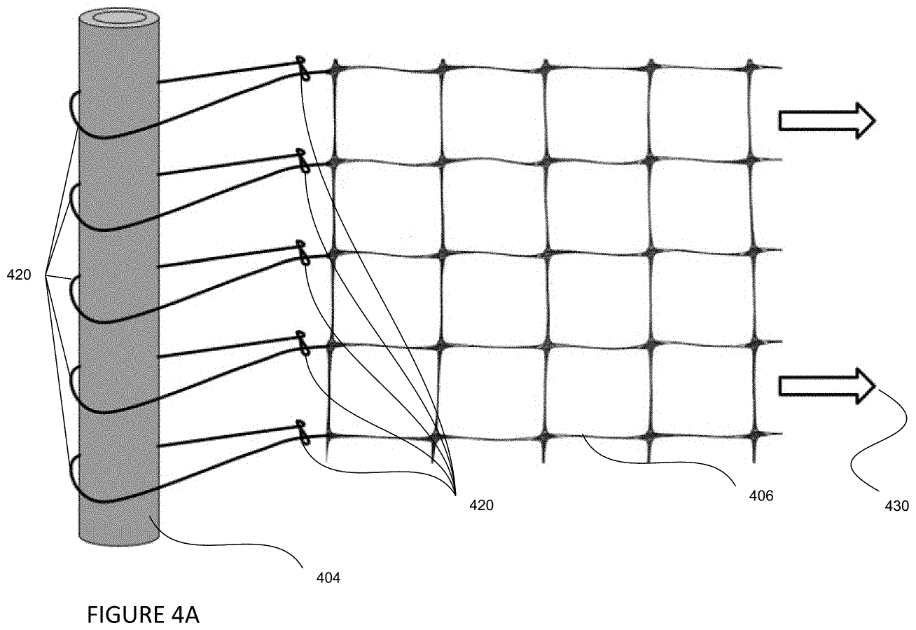

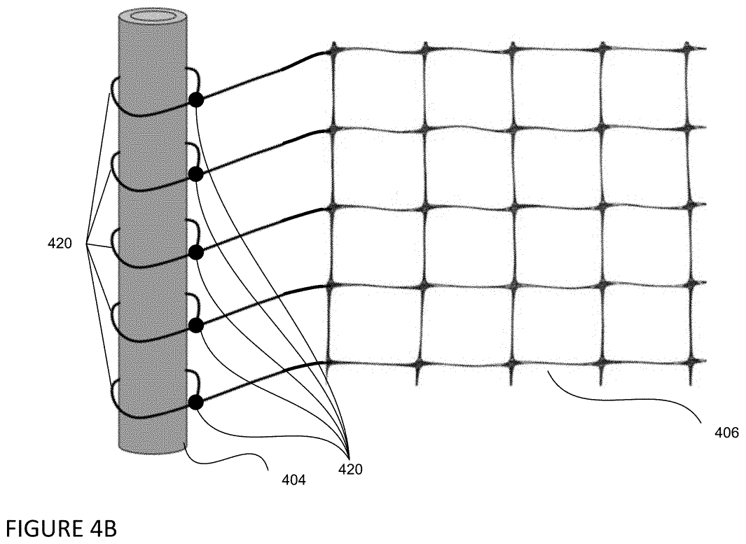

The net may be attached to the supports using various attachment tools, such as cable ties, adhesives, clips, clamps, anchors, hooks, snaps, hook and loop straps, cords looped into holes in the supports, sleeves on each side of the net, etc. Additionally, the net may be attached to the supports using and energy reduction structure such as a net anchor slip knot. For example, the strands of the net 406, which is an example configuration of the net 206, may be terminated with a net anchor slip knot and attached to the supports as shown in FIG. 4A. The net anchor slip knots 420 may allow the strands of the net 406 to slide through the knot. In this regard, the net 406 may be attached to the support 404 by wrapping the strands of the net around the support and passing them through the net anchor slip knots 420.

Upon a pedestrian, passenger, or object impacting the net, the tension in the strands of the net may increase. The tension may cause the strands to slip through the net anchor slip knots until the knots are taut against the support. For example, as further shown in FIG. 4A, upon a pedestrian or object impacting the net 406, the net may be subjected to a force in a first direction 430. The force in the first direction may cause the strands of the net 406 to pass through the net anchor slip knots 420 until the net anchor slip knots are pulled taut against the support 404, as shown in FIG. 4B. As the strands of the net 406 pass through the net anchor slip knots 420, energy of the impact is absorbed by the net 406.

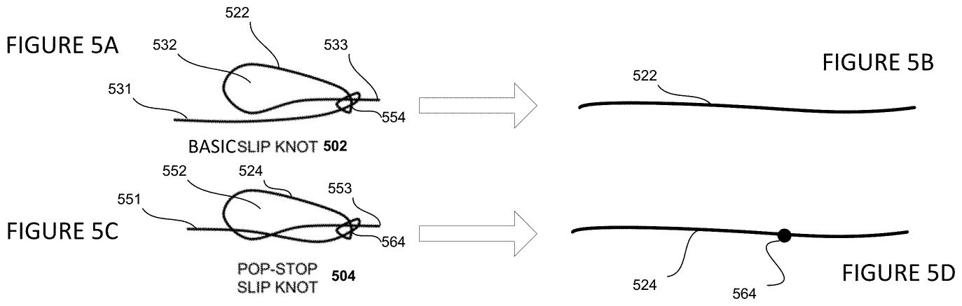

Energy reduction structures such as basic slip knots, pop-stop slip knots, link breaking devices, hobbling strings, etc., may also be used as energy reduction structures within the net. As shown in FIG. 5A, a basic slip knot 502 is made from a strand 522 including a first end 531 and a second, end 533. The strand 522 is knotted to create a knot 554 and a loop 532. As a pulling force is applied to the strand, such that the first end 531 is pulled in a direction away from the second end 533, or vice versa, the portion of the strand which makes the loop 532 is pulled through the knot 554. When the loop of the basic slip knot passes through the knot, the knot may untie. The untying of the knot may result in an extension of the strand with no additional energy absorption. For instance, upon the loop 532 of the basic knot 502 passing completely through the knot 554, the knot 554 may untie. Once the knot 554 unties, the strand 522 may fully extend as shown in FIG. 5B.

The pop-stop slip knot prevents the knot from untying, thereby avoiding the additional, non-energy absorbing extension of the strand as occurs in a basic slip knot. For instance, as shown in FIG. 5C, the pop-stop slip knot 504 is similar to the basic slip knot 502 in that the pop-stop slip knot is made from a strand 524 including a first end 551 and a second, end 553. The strand 524 is knotted to create a knot 564 and a loop 552. The pop-stop slip knot 504 differs from the basic slip knot 502 in that the first end 551 of the strand 524 is passed through the loop 552. As a pulling force is applied to the strand, such that the first end 551 is pulled in a direction away from the second end 553, or vice versa, the portion of the strand which makes the loop 552 is pulled through the knot 564. When the loop passes through the knot 564, the knot is pulled taut and remains in the strand 524, as shown in FIG. 5D. Therefore, the pop-stop slip knot 504 prevents the strand from further extending beyond the length of the loop 552.

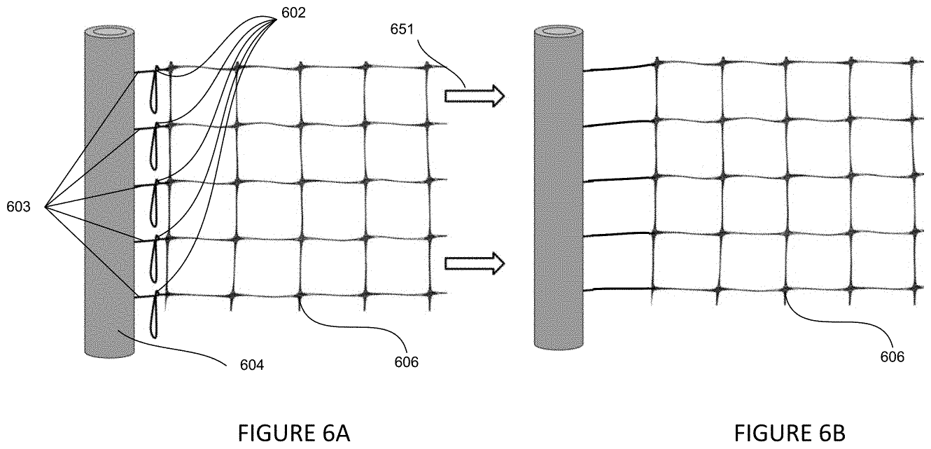

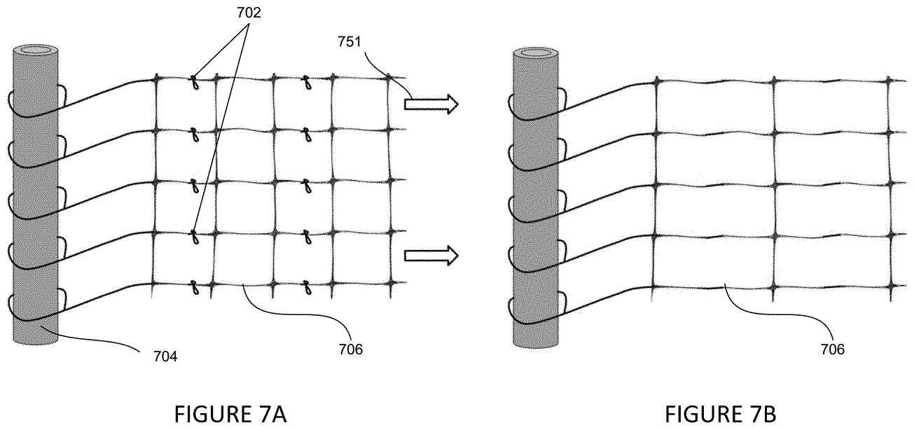

As noted above, slip knots, including pop-stop slip knots and basic slip knots, may be positioned within the net. For example, as shown in FIG. 6A, slip knots 602 may be positioned on the strands 603 of the net 606, which is one example configuration of the net 206. The strands 603 may connect to a support 604. As a pulling force 651 is applied to the net 606, the slip knots 602 may unwind, until the slip knots untie, as shown in FIG. 6B. The slip knots may be spaced evenly throughout the net, although the spacing of the slip knots may be uneven. For example, as shown in FIG. 7B, a net 706, which is one example configuration of the net 206, may be attached to a support 704. The net may have a collection of slip knots 702 spaced evenly throughout. Although FIG. 7A shows ten slip knots, only two are labeled for visual clarity. As a pulling force 751 is applied to the net 706, the slip knots 702 may unwind, until the slip knots completely untie, as shown in FIG. 7B.

Again, the number and placement of slip knots within the net may be dependent upon the amount of energy absorption needed. In this regard, the more slip knots within the net, the more energy the net will absorb as the slip knots unwind. In addition, the energy absorption of the slip knots may be adjusted based on the length of the loop used to make the slip knot. As described herein, the string, or other material, which comprises the slip knot will untie causing the string to lengthen upon a force being applied. As the slip knot unties, energy is absorbed by the net. For, a typical slip knot may be around 6.5 times the size of the loop, with longer loops lengthening the net more than smaller loops. Accordingly, longer loops will allow more energy absorption than smaller loops, as more energy is required to fully lengthen a slip knot with a larger loop. For net anchor slip knots, the energy absorption may be adjusted based on the length of the strands which pass through the net anchor slip knots before they contact the support.

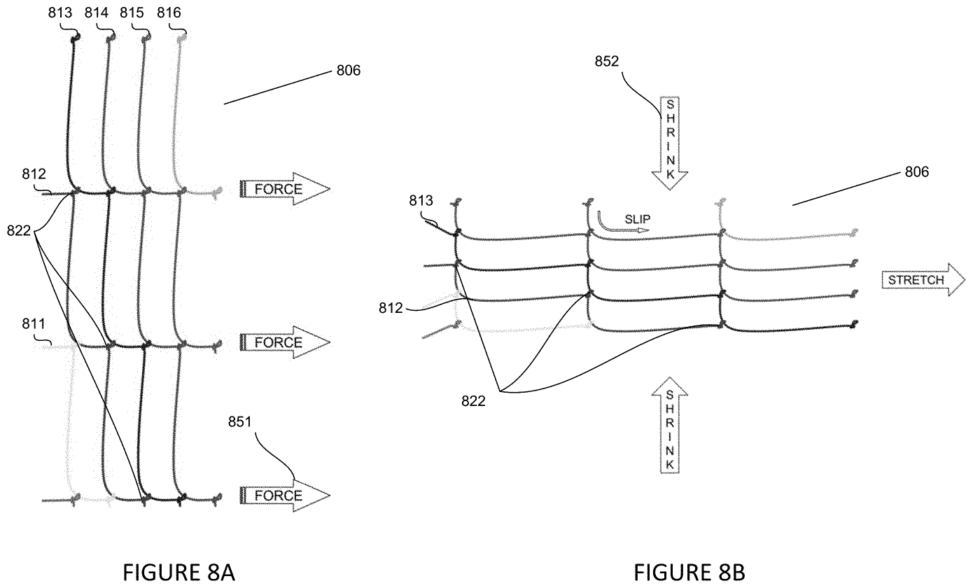

Slip knots may be formed from two or more strands of a net. In this regard, each strand may include one or more slip knots which include one or more loops through which an adjacent strand may pass. Upon impact with an object, the strands may be pulled through their respective slip knots, thereby absorbing energy. For example, as shown in FIG. 8A, a net 806 may be made from multiple strands 811-816. Each strand may include one or more knots, such as knots 822 on strand 812. Strand 813 may be threaded through the loops of the knots 822. The other strands may be threaded through the loops of slip knots in their respective adjacent strands.

Upon a force being applied to the net, the multiple strands may slip through the loops of the knots through which they are threaded. For instance, as shown in FIG. 8B, upon a force impacting net 806, which is one example configuration of the net 206, strand 813 may slip through the slip knots 822 of strand 812. Similarly, the other strands may slip through the loops through which they are threaded. As the multiple strands 811-816 slip through the slip knots, the net 806 may stretch in the direction of the force 851 while simultaneously shrinking in a second direction 852 perpendicular to the force, as further shown in FIG. 8B.

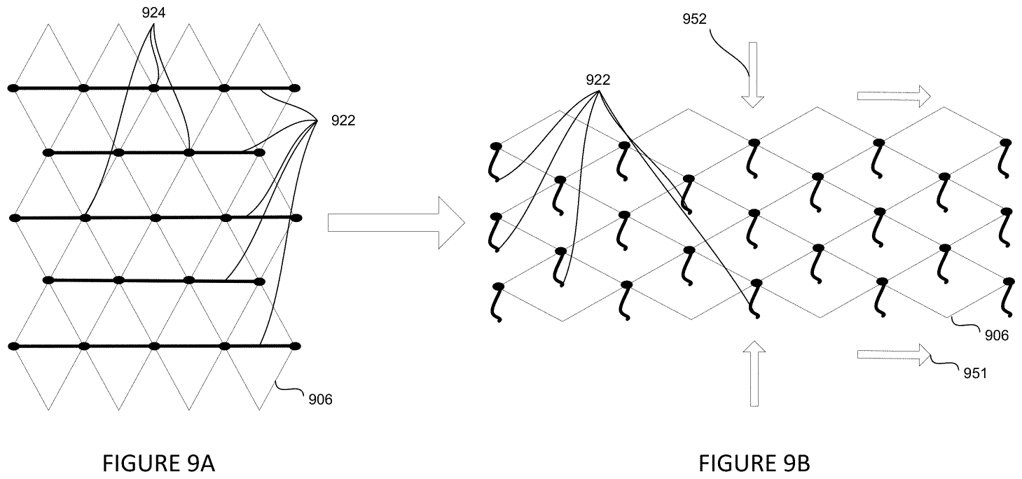

In addition or alternatively, hobbling strings may be used as energy reduction structures within the net. In this regard, hobbling strings may be attached to nodes of a net, thereby causing the nodes to be positioned closer together than if no hobbling strings were attached to the net. The hobbling strings may absorb impact energy by breaking at a predetermined tension, thereby allowing the nodes to stretch apart. For example, hobbling strings, such as hobbling strings 922 may be attached to nodes of the net 906, which is one example configuration of the net 206, such as nodes 924, as shown in FIG. 9A.

Upon impact with a pedestrian, a predetermined impact threshold may be reached, causing the hobbling strings to break and allowing the net to absorb energy in this breaking. The predetermined impact threshold may be about 40,000 N for 50% of the male population, or more or less and may be dependent upon the number of cables in the net. For instance, a force 951 may be applied to the net 906 upon an object colliding with the net as shown in FIG. 9B. Once the force 951 surpasses a predetermined impact threshold, the hobbling strings 922 may break (as shown between FIGS. 9A and 9b) and the net 906 may stretch in the direction of the force 951, while simultaneously shrinking in a second direction 952 perpendicular to the force, as further shown in FIG. 9B. In some instances, a net may include hobbling strings designed to break at different tensions, to allow for controlled energy absorption.

In addition or alternatively, the net may include link breaking (e.g., stitch ripping) devices to absorb impact energy. In this regard, section of the net may be overlapped and stitched together. Upon the link breaking device experiencing a predetermined level of tension, the stitches may break resulting in the lengthening of the net. Dependent upon the strength of the stitching material, the level of tension required to break the link breaking device may be adjusted, thereby allowing for controlled release of the link breaking device.

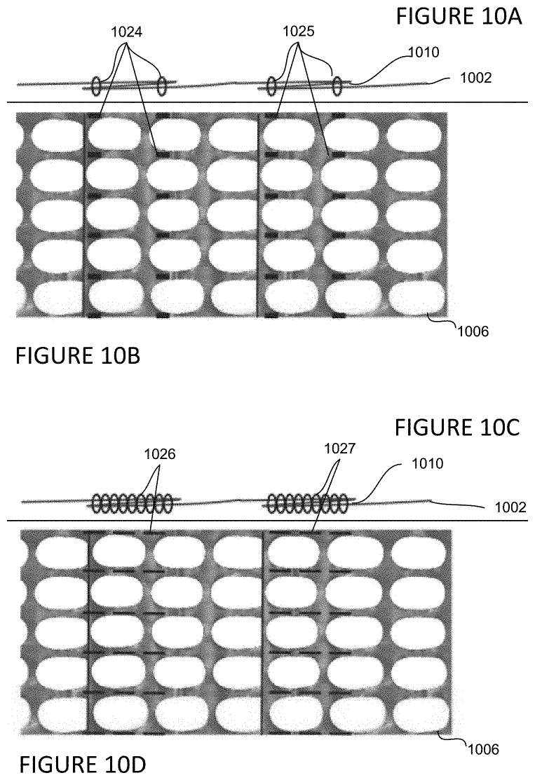

For example, FIGS. 10B and 10D show a front view of the net 1006 made up of a material 1002. The net 1002, which is one example configuration of the net 206, is overlapped at portions 1010 and stitched together. Referring to FIG. 10A, which shows a top down view of the net in FIG. 10B, the overlapped portion 1010 may be stitched together with few stitches 1024 and 1025. In contrast, the overlapped portion 1010 is stitched together with more stitches 1026 and 1027 as shown in FIG. 10C which shops a top down view of the net in FIG. 10D. As such, the stitches of FIG. 10B will break at a lower level of tension than those of FIG. 10D. In some instances the net may be used to anchor the net to one or more supports.

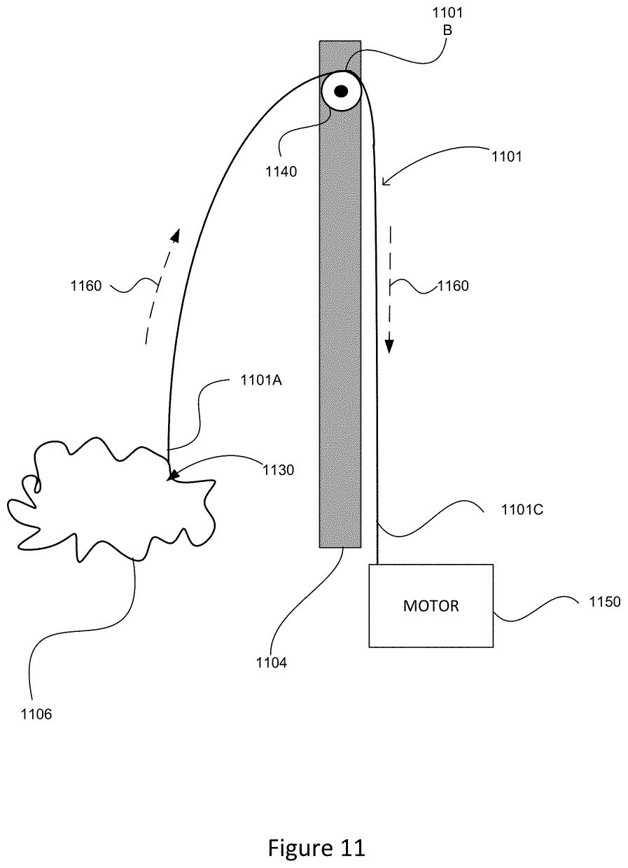

In another embodiment, the net may be attached to the supports via a cable as shown in FIG. 11. In this regard, a first end 1101A of a cable 1101 may be attached to a portion 1130 of the net 1106, which is one example configuration of the net 206. A middle portion 1101B of the cable 1101 may be looped around a pulley 1140 mounted on a support 1104 and a second end 1101C of the cable 1101 may be attached to a motor 1150. Upon impact, the motor 1150 may pull the second end 1101C of the cable 1101 around the pulley 1140 and wind the cable 1101 around an internal component (not shown) within the motor 1150. The cable pull in the direction 1160 may bring up the portion 1130 of the net attached to the cable 1101 and extend the net 1106. Although FIG. 11 shows the use of a motor to pull the cable 1101 around the pulley 1140, a pyroactuator or pneumatic actuator may also be used.

The supports may be in various shapes. For example, the supports maybe tubes, plates, solid structures, hollow structures, etc. The cross section of the supports may be circular, oval, rectangular, polygonal, etc.

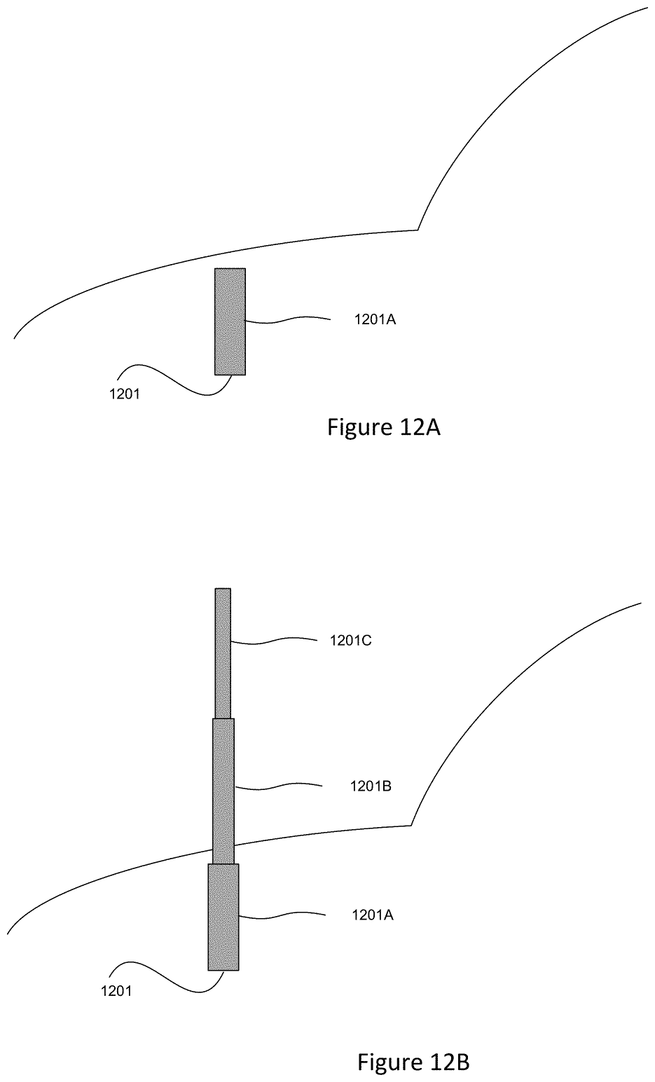

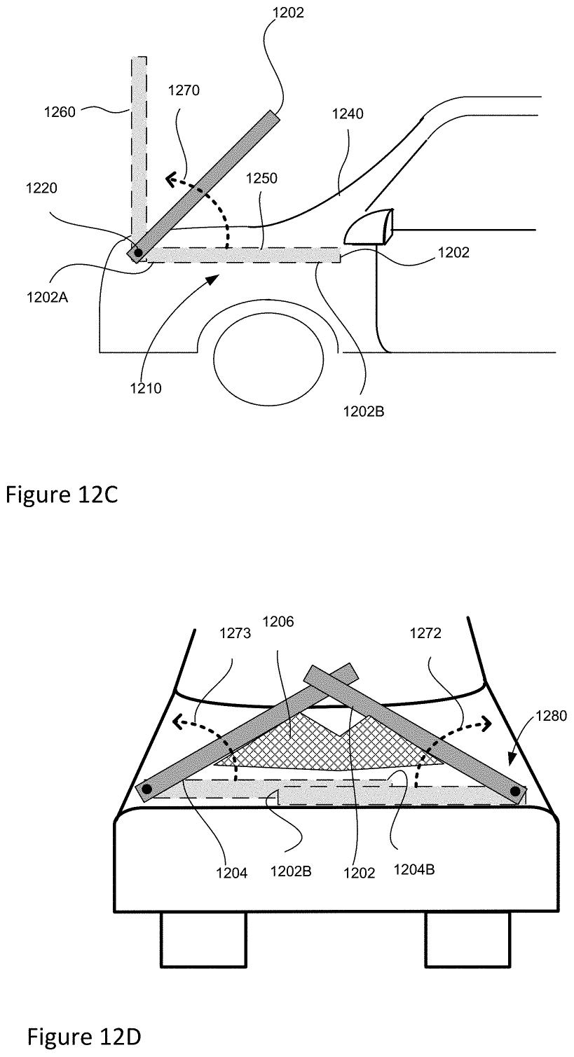

The supports may also be configured to project from the vehicle upon deployment. In this regard, the supports may telescope, swing, or otherwise release from their stowed position to an erected position. For example, as shown in FIGS. 5A and 5B, the supports, such as supports 304, 305, and/or 1104, may include telescoping tubes 501. The telescoping tubes may be made of metal or other such hard materials, such as aluminum, iron, copper, nickel, tin, carbon fiber, etc. Each telescoping tube may be comprised of one or more stages. In this regard, as shown in FIG. 12A, prior to deployment, stage 1201B may be stored within an outer stage 1201A, and stage 1201C may be stored within stage 1201B.

The telescoping tubes may expand vertically upwards from a stowed position to an open position upon detection of an impact. In this regard, prior to the impact, the telescoping tubes 1201 may remain in a stowed position within a compartment, as shown in FIG. 12A. Upon detection of impact, compressed gas may be pushed into metered openings of the tubes in the grid of telescoping tubes. As such, the telescoping tubes may expand, as shown in FIG. 12B. For instance, the outer stage 1201A may expand first, followed by each of the other one or more stages stored within the outer stage, as shown in FIG. 12B. For example, as shown in FIG. 12B, stage 1201A may expand first, followed by stages 1201B, and 1201C, respectively. Alternatively or in addition, each telescoping tube may be expanded through individual or shared expansion devices, such as explosives, pumps, electrical actuators, or compressed springs.

In some embodiments the supports may be configured to swing into a deployed position, thereby extending the net across the vehicle. In this regard, the supports may be in the shape of tubes, telescoping tubes, plates, etc. The supports may be made of metal or other such hard materials, such as aluminum, iron, copper, nickel, tin, carbon fiber, etc. The supports maybe positioned on a portion of the vehicle horizontally relative to a ground on which the vehicle is positioned. The base of a support may be mounted to the vehicle at a pivot point. The support may be configured to swing up, pivoting about the pivot point, to a vertical position relative to the ground. When a vertical position is reached, the supports may come to a stop upon contact with a stopper. For example, the stopper may be an internal bumper, a latch, a sprawl, etc.

For example, as shown in FIG. 12C, a support 1202 is initially positioned horizontally across the side of a fender 1210 of vehicle 100, where the base 1202A of the support 1202 is mounted at a pivot point 1220 adjacent to a front corner 1230 of the vehicle 100 away from the windshield 1240, and the top portion 1202B of the support 1202 is adjacent to the windshield 1240. The support 1202 may be configured to swing up in the direction 1270 from the horizontal position 1250 to a vertical position 1260, being pivoted about the pivot point 1220. In another example, as shown in FIG. 12D, two supports 1202 and 1204 are horizontally positioned on hood panel 1280, with the two supports being parallel and adjacent to each other. Here the top portions 1202B and 1204B of the supports 1202 and 1204, respectively, are also away from the windshield 1240, and the supports 1202 and 1204 are configured to swing up in the direction 1272 and 1273, crisscrossing each other, thereby extending the net 1206 across the front of the vehicle.

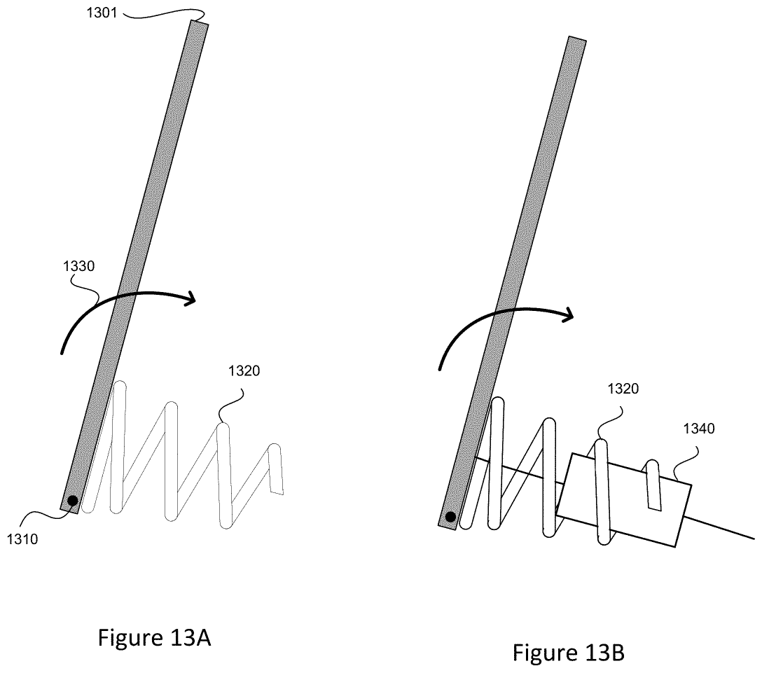

The supports may be configured to pivot toward the vehicle on contact with a pedestrian when in the vertical position after deployment. In this regard, the pivot point may be augmented by a spring to provide resistance after an impact with a pedestrian. The spring may be torsional or linear. For example, as shown in FIG. 13A, the pivot point 1310 of the support 1301 is augmented by spring 1320, which helps support 1301 pivot towards the vehicle in direction 1330 while providing resistance. In some embodiments the spring may include a shock absorber. In this regard, upon a force being applied to the net, the supports may push further into the spring. The shock absorber may absorb some of the energy of the impact force. For example, as shown in FIG. 13B, the spring 1320 may be augmented with a damper 1340 to absorb shock from the impact. The support may also be designed for one way rotation so that after pivoting towards the vehicle, it does not spring back towards the opposite direction. This would decrease pedestrian rebound after impact with the external net system. The one way rotation may be accomplished with a ratchet device (not shown) coupled to the spring.

As noted above, a deployment tool may be used to accomplish the deployment of the supports and/or the net. The deployment tool may include springs, compressed gas devices, pyrotechnic devices, pumps, pneumatics, electrical actuators, etc. to release supports from a stowed position to a deployed position. For example, spring 1320 shown in FIG. 13A may also be used as a deployment tool. The spring may provide motive force to bring the support from a stowed position into the deployed position. The external net system may be designed to deploy from the compartment upon the vehicle detecting an imminent impact. For instance, the vehicle's computing device may determine that an impact with a pedestrian is imminent, and in response, the vehicle's computing devices may send a signal to deploy an external net system. Upon receiving the signal, the supports may be deployed from a stowed position in the compartment, such that the supports project from the vehicle and suspend a net across a portion of the vehicle as shown in FIGS. 2D, 2E, and 2F.

Once deployed, the net may be extended between supports. Upon impact, a portion of the pedestrian's body may contact the net instead of directly contacting parts of the vehicle, reducing contact forces and hence injury. For example, as shown in FIGS. 2D, 2E, and 2F, pedestrian's upper body may contact net 206 when it is extended between supports 204 and 205 mounted on the hood or the fender of the vehicle.

In addition or alternatively to locations at the front end of the vehicle, a compartment may be located within the rear bumper or trunk of the vehicle, within the vehicles doors, arranged in, across, or below a hood panel under a cosmetic cover (as shown in FIG. 3A), near the leading edge of the hood panel (as shown in FIG. 3B), or inside supports of the external net system.

In some embodiments, the net maybe configured to reduce secondary impact. After the initial impact with the vehicle, a pedestrian may be ejected from (or bounce off of) the external net system in a direction opposite of the direction of the initial impact with the next. As such, the pedestrian may be susceptible to secondary impact injuries, as the pedestrian may hit the ground or another object after being ejected. To minimize or even eliminate the secondary potential impact injuries, the net maybe configured to close in around the pedestrian, or be coated in an adhesive to help retain or slow the release of the pedestrian from the net to reduce injuries caused by a secondary impact. For example, the supports may be configured to bend and lock with one another after the impact, thereby containing the pedestrian within the net. The net may be coated in an adhesive to help retain or slow the release of the object from the net or at least absorb some of the secondary impact forces by slowing the release of the pedestrian from the external net system upon the pedestrian rebounding from the initial impact.

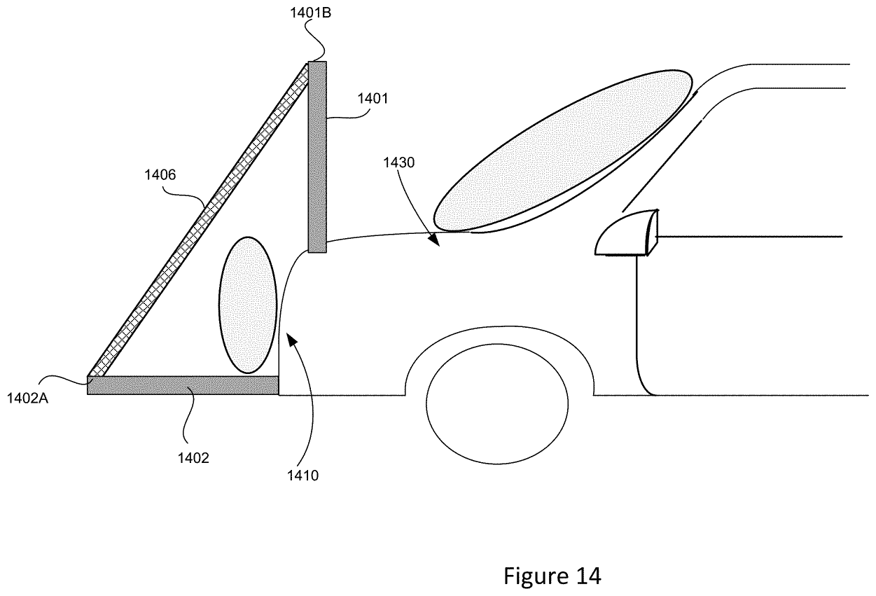

In some embodiments, the external net system may be designed to protect a pedestrian's lower extremities. For example, as shown in FIG. 14, in addition to upper supports 1401 located at the hood panel 1430, one or more lower supports 1402 maybe mounted lower on the vehicle, relative to the ground, such as adjacent to the bumper 1410. Upon detecting an impact, the lower supports 1402 may extend horizontally forward and away from the bumper 1410, and a net 1406, which is one example configuration of the net 206, may extend across the front portion 1402A of the lower supports 1402 to the top portion 1401B of the upper supports 1401, providing coverage for the lower portions of the pedestrian's body. Lower supports 1402 may bend upon impact towards the vehicle and/or towards each other. Lower supports may include tubes, telescoping tubes, plates, solid structures, hollow structures, frames, etc.

In some embodiments, external airbags may be used in conjunction with the external net system to provide additional protection to the pedestrian. For example, as shown in FIG. 14, one or more external airbags 1420 maybe attached to the front of the bumper 1410 and on top of hood panel 1430 behind the supports 1401 to provide additional protection.

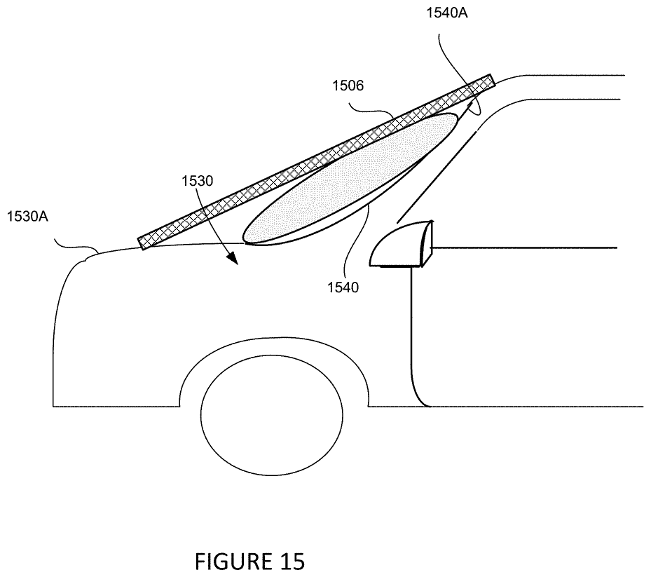

In some embodiments, instead of the supports, only airbags may be placed on the hood of the vehicle. For example, as shown in FIG. 15, an airbag 1540 is used in conjunction with a net 1506. Airbag 1540 is placed on top of the hood 1530 in a stowed position. Net 1506 may be attached to airbag 1540. Upon detecting impact, airbag 1540 is deployed, along with net 1506. Net 1506 extends from the front portion 1530A of the hood 1530 to the top portion 1540A of the windshield 1540, such that the airbag may reduce impact of the injury.

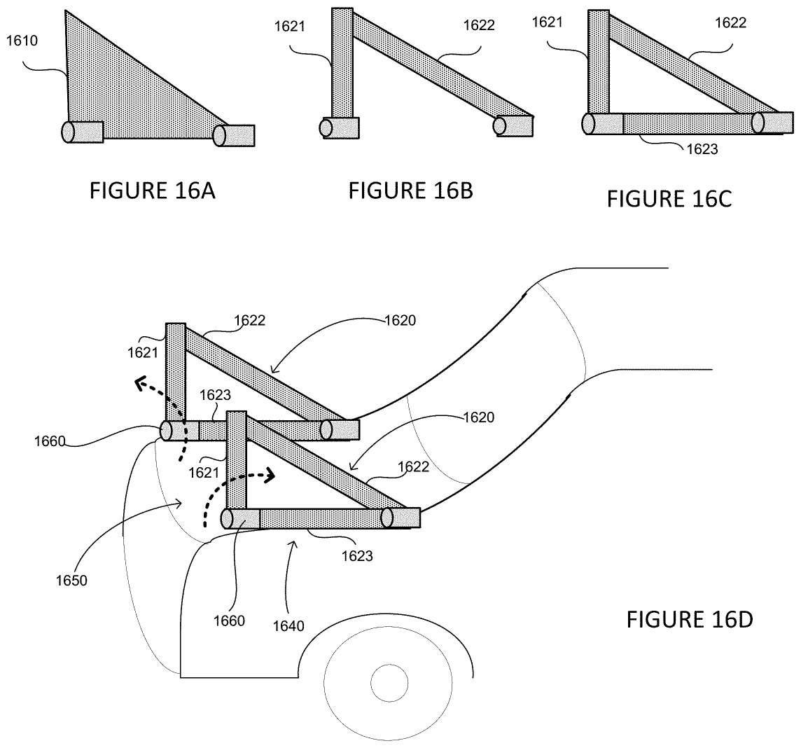

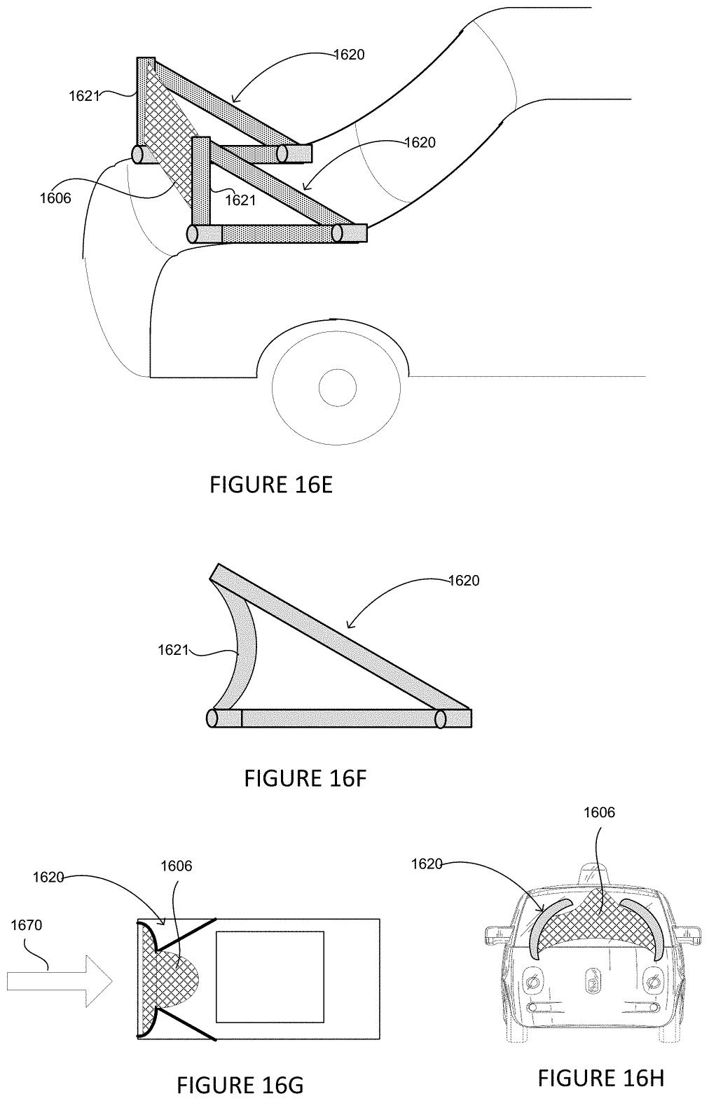

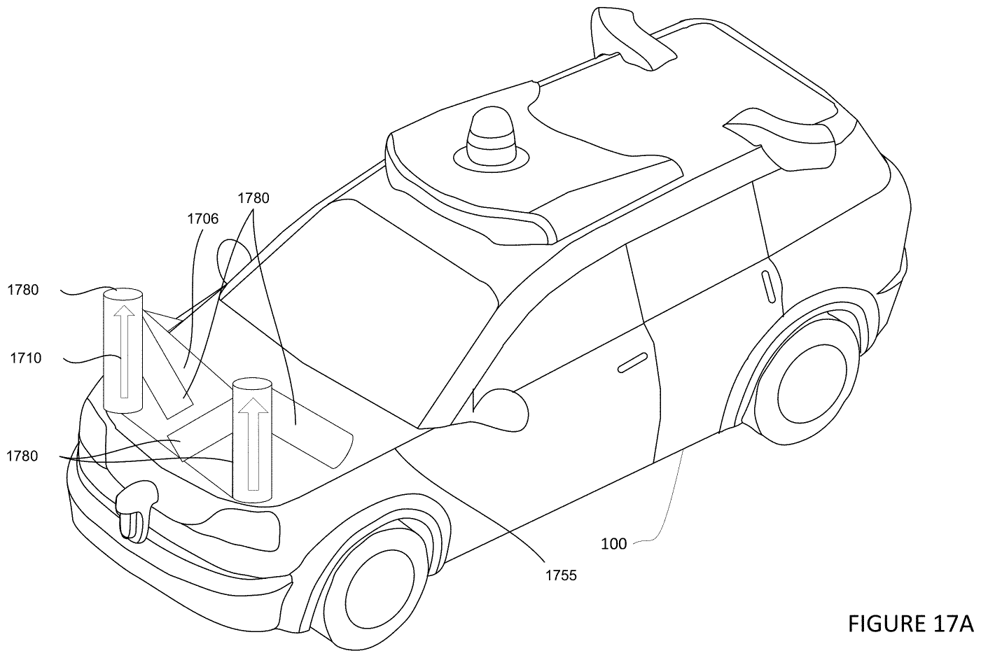

In some embodiments, triangular structures maybe used as supports. For example, as shown in FIGS. 16A, 16B, and 16C, a triangular structure may be a solid plate 1610 (FIG. 16A), or hollow frames with two legs 1621 and 1622 (FIG. 16B) or three legs 1621, 1622, and 1623 (FIG. 16C). As shown in FIG. 16D, two triangular structures 1620 each having three legs 1621, 1622, and 1623 are mounted on the fender 1640 of a vehicle. The base leg 1623 of each triangular structure is laid horizontally across the fender. Before deployment, the triangular structures 1620 may be stowed in a compartment on top of hood panel 1650. Once deployed, the triangular structures 1620 pivot about pivots 1660 on the base leg 1623 from a stowed position to a deployed position. As shown in FIG. 16E, a net 1606 maybe attached on each upright leg 1621 of the triangular structures 1620 and extend upon deployment. Triangular structures 1620 may have curved upright legs 1621, as shown in FIG. 16F, in order to minimize hard edges on pedestrian impact. As the pedestrian contacts the net, the pivots and/or the triangular structures may absorb energy as the net may deflect. As shown in FIGS. 16G (top-view of vehicle) and 16H (front view of vehicle), upon impact in the direction 1670, the triangular structures 1620 may bend towards the vehicle as well as towards each other while the net 1606 is forced backwards towards the vehicle.

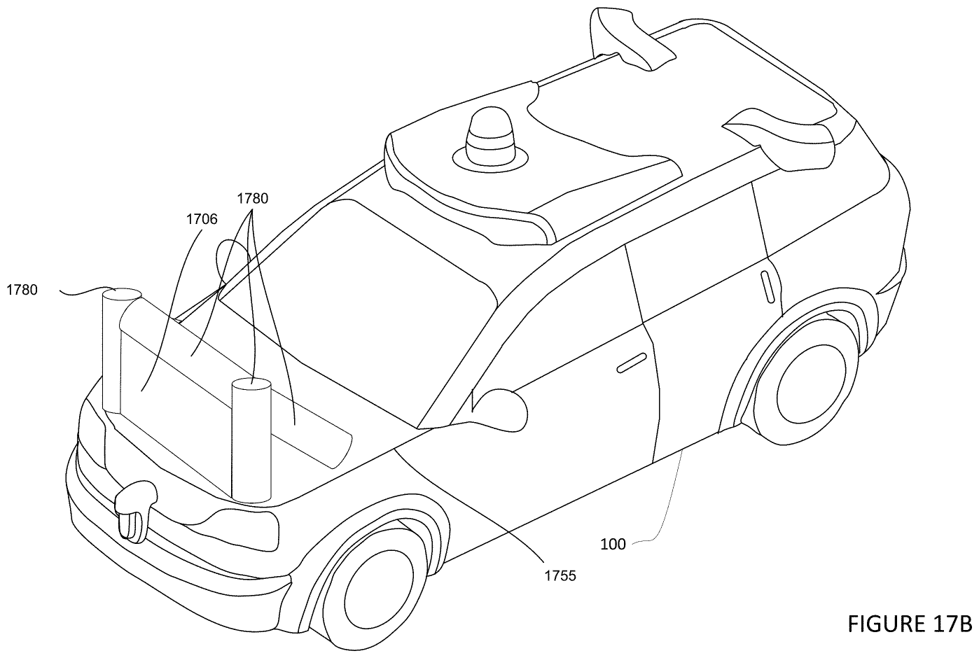

In some examples, airbags maybe used as supports. For example, as shown in FIGS. 17A and 17B are high pressure airbags 1780 maybe mounted on fender 1755 of the vehicle 100. Upon detecting impact, airbags 1780 maybe deployed in an upward direction 1710 relative to the ground to form pressure-stabilized supports. These pressure-stabilized supports may suspend a net 1706 across the vehicle. Although FIGS. 17A and 17B show airbags 1780 as cylindrical, they airbags may be tapered.

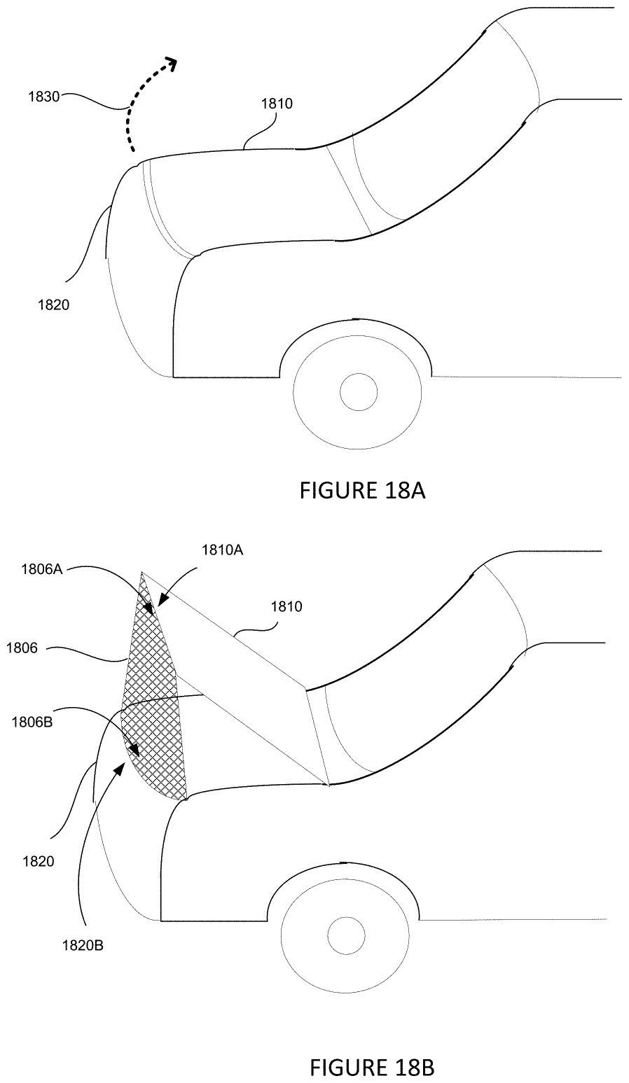

In another embodiment, the net maybe attached to the underside of a vehicle panel, such as a hood, trunk, fender, etc. This configuration may eliminate the need for the supports. For example, as shown in FIGS. 18A and 18B, one side 1806A of the net 1806 is attached to the leading edge 1810A of the hood panel 1810. A second, opposite side 1806B of the net is attached to the top portion 1820B of the bumper 1820. Upon detecting an impact, the hood panel 1810 may be lifted in the direction 1830 to expose the net 1806. In some instances, the front edge of the hood panel may be deformable to reduce injury from impact.

### EXAMPLE METHODS

In addition to the operations described above and illustrated in the figures, various operations will now be described. It should be understood that the following operations do not have to be performed in the precise order described below. Rather, various steps can be handled in a different order or simultaneously, and steps may also be added or omitted.

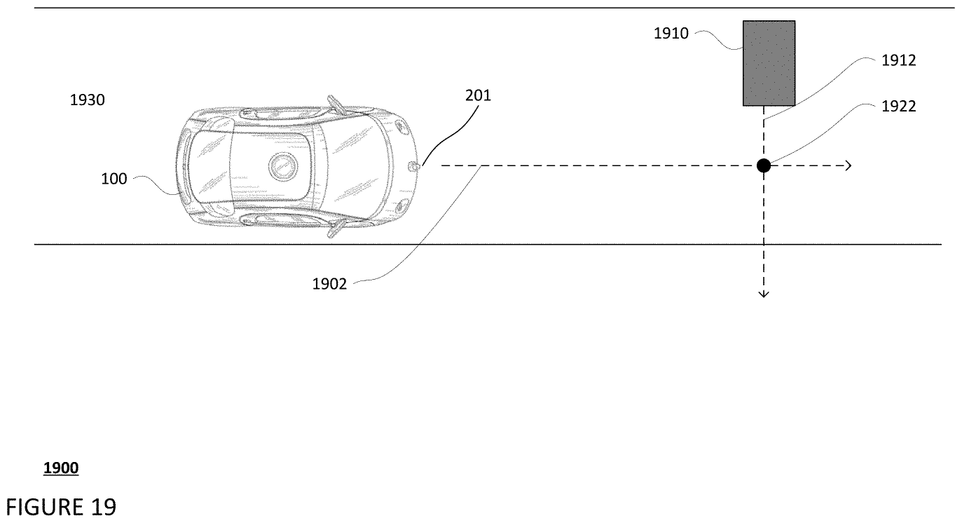

Deployment of the external net system may be done selectively. For instance, deployment may occur in response to a collision or in anticipation of collision based on information from sensors of the vehicle that detect and identify objects in the vehicle's external environment, including pedestrians. For example, to deploy the external net system, a vehicle's computing devices may use information from the vehicle's sensors to identify and track objects in the vehicle's environment. In addition, the vehicle's computing devices may use the characteristics of the object, such as speed and heading, to predict trajectories or future locations where the object and also the vehicle will be. FIG. 19 is an example 1900 bird's eye view of vehicle 100 as it drives along roadway 1930 in the direction of arrow 1902. In this example, the one or more computing devices of the perception system 174 may identify, among other things, the location and objects in the vehicle's environment, such as object 1910. After a brief period of tracking the object, the perception system 174 may determine the speeds and headings of the object as shown by arrows 1912.

In addition, the vehicle's computing devices may use the characteristics of the object, such as speed and heading, to predict future locations where the object will be. For example, as shown in example 1900 of FIG. 19, direction arrow 1902 represents predicted future locations of vehicle 100 and arrow 1912 represents the predicted future locations of object 1910. Because the predicted future locations of these objects are just that, a prediction, predictions may quickly become less accurate the farther into the future they become.

The vehicle's computing devices may also determine whether the future locations indicate that the vehicle will collide with the object (and also approximately where and when). For example, the perception system 174 or computing device 110 may determine that an impact with object 1110 is likely to occur at the locations of predicted impact point 1122, respectively. Each of these impact points may be defined as a three-dimensional coordinate (X, Y, Z) in space such as latitude, longitude, and altitude or similar.

In most cases, if a collision is likely, the vehicle's computing devices may maneuver the vehicle in order to avoid the object. For example, computing device 110 may use the steering, acceleration and deceleration systems to maneuver vehicle 100 out of the path of object 1110.

However if there is not enough time to avoid the object, (i.e. not enough distance, not enough braking power, not enough room to go around or avoid etc.) the vehicle's computing devices may determine that an impact with the object is imminent. For example, an impact may be imminent, when an impact is predicted to occur within a predetermined period of time, such as a few seconds or more or less. When an impact is imminent, the vehicle's computing devices may send a signal to deploy the external net system. This triggering signal may be sent for example by computing device 110, laser sensor 214, or the one or more computing devices of protection system 176.

Once the computing devices have determined to deploy the external net system, a signal from the computing devices may trigger ignition of the deployment tool to deploy the supports and/or the net. For example and referring to FIGS. 12C and 12D, upon triggering the deployment, springs (such as springs 1320 of FIGS. 13A-13B) coupled with stowed supports 1202 and 1204 may be released from a stowed positions 1202B and 1204B. The expansion of the springs 1320 may force the supports 1202 to swing up from a horizontally laid position 1250 to a vertical position 1260, pivoting about pivot point 1220 of the supports 1202. The net 1206 attached to the supports 1202 and 1204 may also rise upwards along with the supports. Thus, the deployed external net system may create a barrier between the pedestrian and parts of the vehicle, reducing contact forces and hence injury.

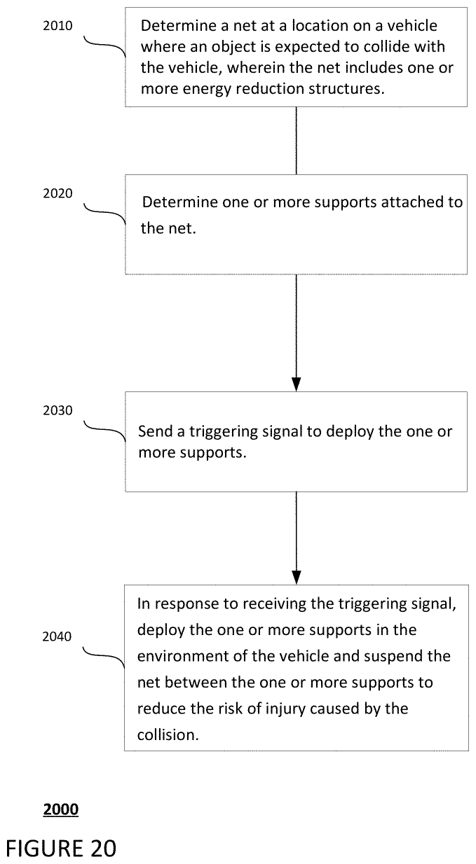

FIG. 20 is an example flow diagram 2000 including a method for reducing likelihood of injury or damage to an object or a pedestrian in a collision with a vehicle, in accordance with some of the aspects described above. For example, at block 2010, a net at a location on a vehicle is determined where an object is expected to collide with the vehicle. At block 2020, supports are determined. The supports are attached to the net. At block 2030, a triggering signal is sent to deploy the supports. At block 2040, the supports are deployed in the vehicle's external environment in response to receiving the triggering signal. Additionally, the net between the supports is suspended to reduce the risk of injury caused by the collision

Although the examples described herein are related to the use of vehicles when operating in autonomous driving modes, such features may also be useful for vehicles operating in manual or semi-autonomous modes or for vehicles having only manual driving mode and semi-autonomous driving modes. In such cases, an active safety mechanism may be identified as discussed above. However, when making the determination as to whether to deploy the active safety mechanism and/or control the vehicle as discussed above, the reaction time of the driver may be compared with the estimated time at which an impact with an object is expected to occur. Reaction times may be determined, for example, by monitoring a specific driver's reaction times over time or by using average or expected reaction times for drivers in general. If the reaction time is too slow, the vehicle's computing device may then use the estimated time when an update will be received to determine whether to deploy the active safety mechanism and, in the case of a vehicle with such capabilities to take control and maneuver the vehicle as discussed in the examples above.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
multiple nets arranged along multiple locations on a vehicle, each net being configured to deploy in an environment external to the vehicle in response to a determination that a collision with an object external to the vehicle is imminent in order to reduce the likelihood of the object colliding directly with the vehicle such that when in a deployed position, each net blocks the object from making contact with the vehicle;
one or more energy reduction structures arranged on each net, wherein the one or more energy reduction structures are configured to reduce injury caused by impact of the object by absorbing impact energy; and
one or more processors configured to:
predict future locations of the vehicle and the object within a predetermined period of time;
determine the collision with the object is imminent based on the prediction of the future locations of the vehicle and the object;
predict an external location on the vehicle where the collision with the object is expected to occur;
determine that a first one of the multiple nets that is deployable at the external location on the vehicle where the collision is expected to occur; and
send a triggering signal to deploy the first net.

2. The system of claim 1, wherein the one or more energy reduction structures include at least one link breaking device.

3. The system of claim 1, wherein the one or more energy reduction structures include at least one hobbling string.

4. The system of claim 3, wherein the at least one hobbling string is configured to tear apart at a predetermined tension threshold.

5. (canceled)

6. The system of claim 2, wherein the at least one link breaking device is configured to tear apart at a predetermined tension threshold.

7. The system of claim 1, wherein the one or more energy reduction structures include one or more slip knots.

8. The system of claim 7, wherein the one or more slip knots include at least one net anchor slip knot, the at least one net anchor slip knot securing each net to one or more supports.

9. The system of claim 8, wherein the one or more energy reduction structures further include at least one other energy reduction structure.

10. The system of claim 7, wherein the one or more slip knots include basic slip knots.

11. The system of claim 7, wherein the one or more slip knots include pop-stop slip knots.

12. The system of claim 7, wherein the one or more slip knots are positioned throughout each net.

13. The system of claim 1, further comprising the vehicle.

14. The system of claim 13, wherein each net is stored in a compartment attached to the vehicle.

15. A method for deploying a net in a vicinity of a vehicle in order to reduce the likelihood of an object external to the vehicle colliding directly with the vehicle comprising:
providing a net system comprising multiple nets arranged along multiple locations on the vehicle;
predicting, by one or more processors, future locations of the vehicle and the object within a predetermined period of time;
determining, by the one or more processors, a collision with the object is imminent based on the prediction of the future locations of the vehicle and the object;
predicting, by the one or more processors, an external location on the vehicle where the collision with the object is expected to occur;
determining that there is a first one of the multiple nets is deployable at the external location on the vehicle where the collision is expected to occur;
sending, by the one or more processors, a triggering signal to deploy the first net; and
in response to receiving the triggering signal, deploying the first net, wherein the first net includes at least one energy reduction structure arranged on the first net, wherein the at least one energy reduction structure is configured to reduce injury caused by impact of the object by absorbing impact energy.

16. The method of claim 15, wherein the at least one energy reduction structure includes at least one link breaking devices, the at least one link breaking device configured to break at a predetermined tension.

17. The method of claim 15, wherein the at least one energy reduction structure includes at least one hobbling string, the at least one hobbling string configured to break at a predetermined tension.

18. The method of claim 15, wherein the deployment of the first one of the multiple nets is accomplished using a deployment tool.

19. The method of claim 15, wherein the at least one energy reduction structure includes at least one basic slip knot or pop-stop slip knot.

20. The method of claim 15, wherein the at least one energy reduction structure includes at least one net anchor slip knot, the at least one net anchor slip knot securing each net to one or more supports.
